(19) United States
(12) Patent Application Publication
(10) Pub. No.: US 2017/0314800 A1
(43) Pub. Date: Nov. 2, 2017

(54) AUTOMATED FUNCTIONAL TESTS FOR DIAGNOSTICS AND CONTROL

(71) Applicant: Carrier Corporation, Farmington, CT (US)

(72) Inventors: Sorin Bengea, Auburn, MA (US); Veronica Adetola, West Hartford, CT (US); Martin Krucinski, Glastonbury, CT (US); Soumik Sarkar, Ames, IA (US); Abhiskek Srivastav, Dublin, CA (US); Teems E. Lovett, Glastonbury, CT (US); Kushal Mukherjee, Cork (IE); Anarta Ghosh, Cork (IE); Mei Chen, Fuzhou, Fujian (CN); Pengfei Li, Manchester, CT (US)

(21) Appl. No.: 15/526,201

(22) PCT Filed: Sep. 11, 2015
(86) PCT No.: PCT/US2015/049675

§ 371 Date: May 11, 2017

Related U.S. Application Data
(60) Provisional application No. 62/078,735, filed on Nov. 12, 2014.

(51) Int. Cl. F24F 11/00; G05B 13/04

(52) U.S. Cl. CPC F24F 11/006; G05B 13/041; F24F 2011/0067; F24F 2011/0052; F24F 2011/0075

(57) ABSTRACT

In one aspect, a method of generating a model for HVAC system control is provided. The method includes generating a model of the performance of an HVAC system, providing the generated model to at least one of an optimal control system and a diagnostic system, and automatically tuning the HVAC system using the generated model and at least one of the optimal control system and the diagnostic system.

### STATEMENT REGARDING FEDERALLY SPONSORED RESEARCH OR DEVELOPMENT

This invention was made with government support under contract number W912HQ-09-C-0056 awarded by the Army Aviation and Missile Command. The government has certain rights in the invention.

### FIELD OF THE INVENTION

The subject matter disclosed herein relates to control and diagnostic systems and, more specifically, to building and HVAC control and diagnostic systems.

### BACKGROUND

Building system controls may be based on mathematical representations of heat transfer for various components at different levels of the system. During long term operation, the components may be affected by malfunctions or the overall system may be subjected to changes that contribute to overall performance degradation. To efficiently control these components, control schedules need to be tuned and the health of the components needs to be estimated on a regular basis. However, a component malfunction is typically determined through an intensive labor effort that includes comparing normal operation data with data from a specific time window when a fault is evident.

Typically, in building and HVAC applications, historical data from different operating conditions is unavailable due to lack of operating condition variability. Functional testing of HVAC equipment and building sub-systems can provide additional data, but often requires numerous manual setpoint changes of actuators. Such manual processes are labor intensive, error prone, and are often a large part of the commissioning costs for advanced diagnostic and control systems.

Accordingly, it is desirable to provide control and diagnostic systems that utilize models and measurement data and provide automatic implementation procedures to reduce manual intervention.

### BRIEF DESCRIPTION OF THE INVENTION

In one aspect, a method of generating a model for HVAC system control is provided. The method includes generating a model of the performance of an HVAC system, providing the generated model to at least one of an optimal control system and a diagnostic system, and automatically tuning the HVAC system using the generated model and at least one of the optimal control system and the diagnostic system.

In another aspect, a method of generating a model for HVAC system control is provided. The method includes generating a combination of input variables for a component of an HVAC system, performing a functional test on the component using the generated input combinations, measuring performance data of the component during the functional test, and generating a model of the component performance over generated input combinations.

In yet another aspect, a method of controlling an HVAC system is provided. The method includes varying input parameters of the HVAC system, measuring performance of the HVAC system while the input parameters are varied, and generating a model of the performance of the HVAC system based on the measured performance. The method further includes utilizing the generated model to automatically optimize the performance of the HVAC system, and comparing actual outputs of the HVAC system with predicted outputs predicted by the model.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an exemplary building automation system;

FIG. 2 is a flow chart of an exemplary HVAC control system;

FIG. 3 is a flow chart of an exemplary method of generating a model for HVAC system control;

FIG. 4 is a flow chart of another exemplary method of generating a model for HVAC system control; and

FIG. 5 is a schematic illustration of an exemplary fault tolerant control system that may be used with the building automation system shown in FIG. 1.

### DETAILED DESCRIPTION OF THE INVENTION

The following description relates to control and diagnostic systems such as, for example, building HVAC control and diagnostic systems, or cooling and heating plants. An objective of building HVAC control systems is to control thermal power generation and distribution to meet occupants' thermal comfort with the lowest possible energy costs. The thermal power generation may be accomplished utilizing components such as chillers and heating plants, and the distribution may be accomplished utilizing components such as air handling units (AHUs) and terminal units located in zones of the building. An objective of the building HVAC diagnostic systems is to detect and isolate faults associated with the HVAC equipment. An objective of the building HVAC fault-tolerant control system is to reconfigured the control system in real-time in order to accommodate the diagnosed faults as soon as they are detected, isolated, and characterized. The reconfiguration of the control system is accomplished in order to meet the occupant thermal comfort while meeting the constraints imposed by the diagnosed faults.

The HVAC control systems utilize measurements from various sensors to generate airflow and temperature levels that provide a desired occupant comfort. For example, the sensors may include water and air temperature sensors, water and air volume rate sensors, occupancy sensors, motion detection sensors, CO2 sensors, humidity sensors, etc. The control systems include control variables such as water (cold and hot) flow volume rates, air flow volume rates, and water and air temperatures. Calculation of the control variables based on sensor measurements is realized by control algorithms. The control algorithms generate periodical updates for the HVAC system based on updated measurement data and are based on a two-level hierarchical structure of a supervisory control and a local control.

As illustrated in FIG. 1, a building automation system 10 includes a supervisory control level 20 and a local control level 30. A sensor data level 40 provides sensor data to supervisory control level 20, and a subsystem control level 50 controls specific HVAC components.

Supervisory control level 20 includes a supervisory controller 22. Local control level 30 includes various local controllers such as, for example, an outside air controller 32, a mixed air controller 34, a supply flow controller 36, a hot deck controller 37, a cold deck controller 38, and a zone supply T controller 39. As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality

In the exemplary embodiment, outside air controller 32 adjusts the outside air damper position, via an actuator, in order to control the ambient air mass flow rate that is supplied to the building. Mixed air controller modifies the positions of several dampers, by means of their actuators, in order to control the mixed air temperature. Supply flow controller 36 controls the total air mass flow rate supplied by an HVAC unit by changing the fan speed. Hot deck controller 27 controls the hot water valve in order to control the air temperature of the hot deck. Cold deck controller 38 modifies the cold water valve in order to control the air temperature of the cold deck. Zone supply T controller 39 adjusts the air mass flow rate and the supply temperature supplied to each zone in order to control the zone air temperature to the requested values. The described controllers receive reference values (or set points) from a supervisory controller that may be integrated in a building management system or reside on a separate machine. In order to meet the reference values, the local controllers modify the actuator positions/values based on sensor data pertaining to the individual HVAC components they control, illustrated in HVAC components 50. However, the controls and components described are exemplary and system 10 may include various other types of controls and components

Sensor data level 40 includes various sources of data such as weather forecast data 42, thermal comfort data 44, zone occupancy data 46, and HVAC data 48. Each of the data sources may include one or more sensors that provide relevant data. For example, weather forecast data 42 may include temperature, humidity, and cloud coverage data over a selected forecast horizon. Thermal comfort data 44 may include zone air temperature sensor data. Zone occupancy data 46 may include motion sensor and occupant counter to provide zone occupancy information. HVAC data 48 may include temperature, CO2, air mass flow rate, and water mass flow rate sensor measurements.

In advanced building automation system 10, the higher supervisory level controller 22 is implemented to generate set points for all HVAC actuator control loops. Controller 22 includes schedules based on which set points are generated. For example, when ambient outdoor temperature and humidity are within predetermined ranges, controller 22 may set a schedule where the supply temperature values are set to a specific value.

The controllers of the lower, local level 30 are implemented directly in the embedded processor of the individual HVAC equipment control hardware. The controllers of local level 30 include simple rules that control the HVAC actuators (e.g., valves, dampers) in order to meet set points generated by the higher level supervisory level 20.

As such, when implemented, the control and diagnostic systems respectively generate some values for the actuators and faults based on simple rules. In many cases, these simple rules are far from optimal and require labor intensive re-tuning and the diagnostic results may consist of large numbers of false alarms (incorrectly diagnosed component health status and failure modes). The simple rules implemented for modern HVAC systems may significantly limit the controller ability to handle various component faults. Further, even when faults are correctly diagnosed, the control system may not be able to change its operation, leading to occupant comport issues. The control and diagnostic systems described herein include additional improvements. The improved systems include model-based representations in addition to or in place of the simple rules/schedules provided by building automation system 10. The improved systems also include a method for estimating parameters of those models and for reconfiguring the control system to accommodate various component faults.

The control system models include equations that relate specific variables to selected inputs. For example, specific variables may include air temperature in occupied zones. Selected inputs may include actuator values such as various damper and valve positions, set points such as supplied air mass flow rate and temperature to all zones, and temperature and flow values for the HVAC system local actuation loops.

Such models are more complex than the simple rules/schedules used in most HVAC systems and include equations that contain various parameters. The equation type and parameter values are critical in generating a desired representation or model of the HVAC system behavior. With the desired representations, the control and diagnostics systems may reliably meet their performance targets, require less labor-intensive recalibration, and robustly accommodate various component faults.

The method for estimating the model parameters includes a set of algorithms that generate specific HVAC effectors commands that enable estimation of parameters of selected HVAC components. These effector commands include specific coordinated actuator commands executed during a selected time interval. For example, to estimate the thermal inertia and the load in a specific zone, the effector commands are either damper and hot/cold position (at the actuator level) or the corresponding set points (supplied air temperature and air mass flow rate). These effectors are coordinated and varied over a period of time (e.g., a few hours) in such a way that the correlation between their values and the resulting zone temperature reveals the sough model parameters.

The generated HVAC effectors commands are designed to control and vary operational parameters (e.g., supply temperatures, air/water flows, etc.) of specific components across various operational ranges. As a result, the component dynamical features become transparent and the information content of sensor measurements is maximized The specific actuator commands are designed based on initial models with unknown parameters, loads, and/or flow distributions, and are designed to use features of the models that increase the impact of the sought parameters, loads, and/or flows on measurements. This maximizes the potential for estimating such quantities. As criteria, the algorithms for effectors command generation use a metric that depends on the specific parameters to be estimated.

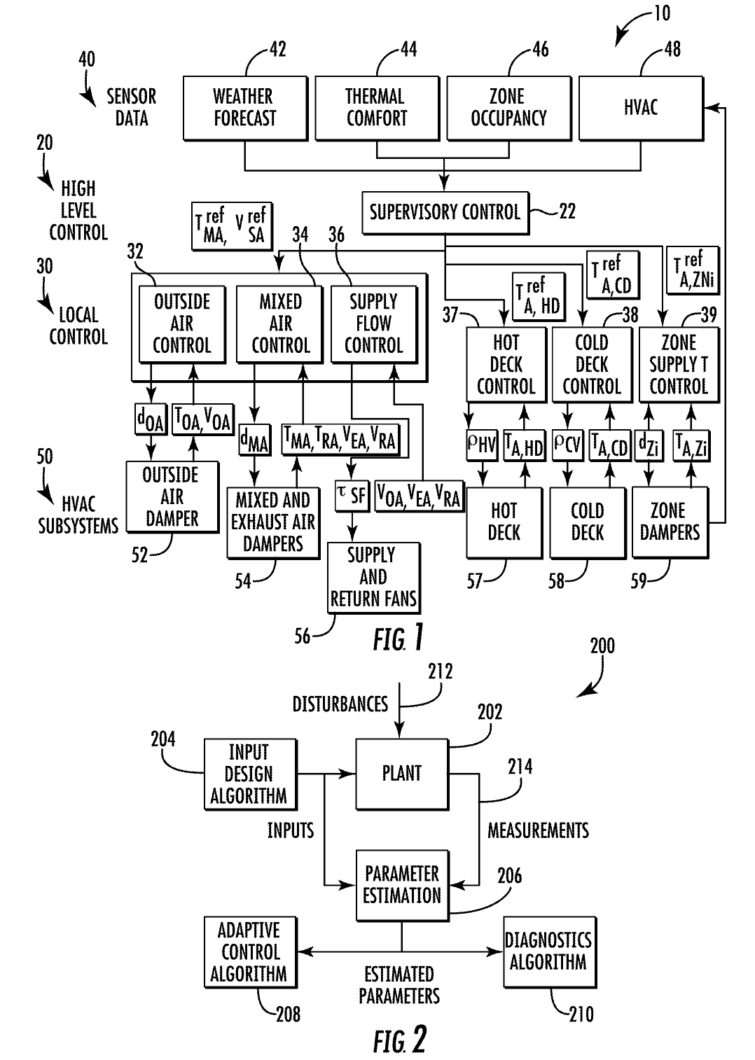

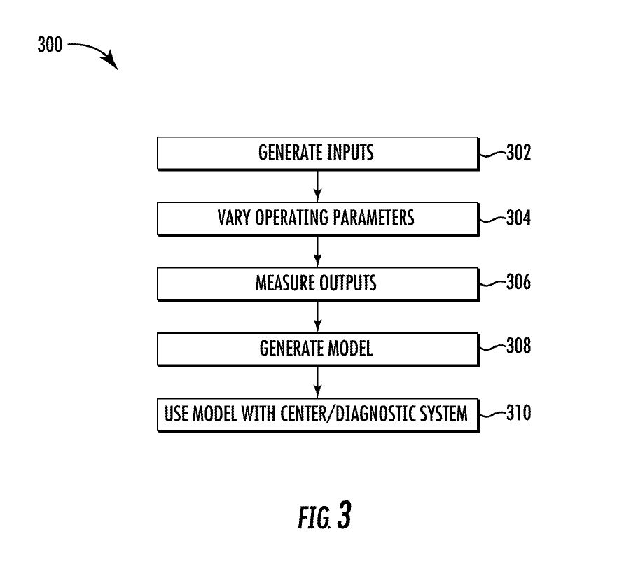

As illustrated in FIG. 2, the method for estimating the model parameters may be used as part of an adaptive and/or fault tolerant HVAC control system 200. By periodically estimating model parameters associated with the control and/or diagnostics systems, system 200 may self-configure and tolerate faults.

In the exemplary embodiment, HVAC control system 200 includes a plant controller 202, an input design algorithm module 204, a parameter estimation module 206, an adaptive control algorithm module 208, and a diagnostics algorithm module 210. Plant controller 202 controls an HVAC system including its various components and receives input parameters from input design algorithm module 204 to operate the plant and its components.

Module 204 generates a sequence of input parameters to excite or operate the plant and its components in a wide range of operating points (rather than wait for the conditions to occur). This provides varied performance characteristics or data sets from different operating conditions of the plant components, which may later be used for optimal control or diagnostics of plant 202. The input parameters may include, for example, altering the flow through a heat exchanger, altering an inlet temperature of the heat exchanger, altering the hot/cold water valve positions, altering the air flow and supplied temperature to a specific zone.

Disturbances 212 may affect plant 202 and its components and may include disturbances such as, for example, changes in weather, changes in ambient temperature, changes in number of occupants, and changes in temperatures on the boundaries of the controlled zones. The disturbances affect the measurement and the impact on the estimated parameter values. The functional tests described herein maximize the information contained in the sensor data to separate the disturbances/loads from the actual parameter values.

The designated inputs from module 204 and resulting measurements 214 for the component operating ranges are used to generate a model of the component performance, which may be supplied to parameter estimation module 206. In the exemplary embodiment, module 206 utilizes the model to predict outputs of the HVAC system and/or components. The estimated outputs (along with actual measured outputs) may then be used with adaptive control module 208 and with diagnostics module 210. The adaptive control algorithms use the estimated parameter values to change the inputs in order to optimize the system performance while meeting comfort restraints. The diagnostics algorithm uses the value to learn parameters and model to detect and isolate faults during normal operation. For example, if the outlet temperature of the hot/cold deck does not correspond to a predicted value (based on inlet temperature, air flow, and valve position), this may lead to an increased likelihood of a faulty component. If more evidence is favorable toward this hypothesis, the likelihood of a fault increases. As such, the HVAC system may then be automatically controlled to optimize the system performance based on the generated model and parameter estimation module 206.

As such, HVAC system 200 provides reduced commissioning and control re-tuning. By employing models to represent the HVAC system behavior, a significant part of the manual tuning conducted for existing systems can be replaced by the described automated features implemented into the building automation system such as that described in FIG. 1. The automated features are implemented as algorithms and executed periodically (e.g., once per season). The automated features additionally replace the manual tasks associated with detecting when control gains need to be retuned, retuning processes, monitoring the performance of the new gains, and then reiterating as needed to meet satisfactory performance levels.

HVAC system 200 also increases system performance and reliability. When the HVAC subsystems (actuators, heat exchangers, etc.) are healthy, the accurate estimates of the parameters, which are generated by means of the described methods, are employed by the control system to optimize the overall HVAC system performance. This is realized by an optimization-based control algorithm, which generates inputs and maximizes the overall efficiency, while meeting component and comfort restraints. For example, accurate knowledge of the thermal inertia of the served zones, enables the control algorithms to provide optimal thermal power levels. During long term operation, the HVAC components are affected by malfunctions and/or the overall system is subjected to changes contributing to performance degradation. However, system 200 utilizes models and measurement data to provide an automatic implementation procedure that reduces the manual intervention associated with recalibration and system health status estimation. This is realized through the implementation of a Fault-Tolerant Control System, which integrates the described Diagnostics and Optimal Control System. This integrated system accommodates the HVAC subsystem faults, by using the fault information to adapt the control algorithms. For example, when the Diagnostics module isolates and characterizes the fault associated with the damper or valve, whose operational range may become restricted in time, the control system uses this new information to generate control inputs that are optimal within this restricted range. Existing HVAC control systems do not detect and utilize this information as described herein, which may result in lack of comfort or excessive energy consumption.

FIG. 5 illustrates an exemplary fault-tolerant control system 500 providing a fault tolerant architecture. Fault-tolerant control system 500 includes a supervisory fault-tolerant control level 510. A sensor data level 530 provides sensor data to supervisory fault-tolerant control level 510, and a subsystem control level 540 controls specific HVAC components.

Supervisory fault-tolerant control level 510 includes a fault detection and diagnostics control module 512 and a model predictive control module 514. Fault detection and diagnostics control module 512 includes fault models 516, which include correlations between HVAC component variables and sensor measurements, and detect algorithms, which generate signals indicative of faults when the predicted outputs are different than sensor measurements; and fault isolation logic 518, which uses the signals indicative of faults to identify or determine the faulty HVAC components. Model predictive control module 514 includes prediction models module 520, which is used to estimate the HVAC variables, electrical and power consumption levels, and zone temperatures over selected time horizons; component constraints module 522, which includes component operational constraints (actuator ranges, maximum electrical and thermal power levels, temperatures, etc.); and optimization algorithm module 524, which generates values of the HVAC actuators and set points by solving an optimization problem formulation which includes the mentioned models, constraints, weather and occupancy forecasts, and control objectives.

Sensor data level 530 includes various sources of data such as heating/cooling plant data 532, building AHU/VAV data 534, building zone data 536, and weather forecast data 538. Each of the data sources may include one or more sensors that provide relevant data. For example, heating/cooling plant data 532 may include water temperatures and pressures at various points in the flow, air and water flow rates, and power consumption levels; building AHU/VAV data 534 may include air and water flow rates, air and water temperatures, damper and valve positions, and electrical and thermal power meter data; building zone data 536 may include space temperature and humidity, and occupancy sensor data; and weather forecast data 538 may include temperature, humidity, and cloud coverage data over a selected forecast horizon.

Subsystem control level 540 includes various local controllers such as, for example, an AHU controller 542 and a VAV controller 544.

In the exemplary embodiment, fault detection and diagnostics module 512 receives sensor data from sensor data level 530 and determines and identifies if operational faults exist in HVAC components. If component faults are detected, a signal indicative of the component fault is sent to model predictive control module 514, which then determines new operational set points or parameters for controllers at the subsystem control level 540. As such, the control system can adapt to varying health of components (e.g., varying performance issues) while still meeting comfort requirements.

With reference to FIG. 3, a method 300 of generating a model for HVAC system control is described. Method 300 generates a model of the performance of the HVAC system, which may include modeling the performance of one or more components of the HVAC system. The method includes, at step 302, generating a sequence of inputs to maximize and vary the operating range of the HVAC system or certain components. The operating change is maximized by generating inputs (temperature, airflow, actuator positions, etc.) with ranges that span the entire range of each input, which ensures that the system response is generated in a large number of representative operational scenarios, which facilitate accurate parameter estimates. At step 304, operating parameters of the system/components are varied based on the generated inputs to excite the overall HVAC system into a wide range of operating conditions.

At step 306, data sets and the performance outputs of the system/components are measured as the operating parameters are varied to capture the behavior of the system/components in the varied operating ranges. At step 308, a model of the system/component behavior is generated based on the measured system/component data and performance. At step 310, the generated model is used with at least one of an optimal control system and a diagnostic system to automatically tune the HVAC system/component to optimize the HVAC efficiency, as described herein.

Further, the HVAC system may include an automated process that performs the design of experiments while satisfying required time constraints and that executes functional tests of those designed experiments. The process includes gathering of individual requirements and constraints of the HVAC system and building sub-systems and automatically generating an overall, optimal test plan. The process then executes the functional test using electronic overrides of actuators, setpoints, and sensor values. The process may also include on-line monitoring of the functional tests for safety and building operation constraints. As such, the automated process helps develop, validate, and calibrate control and diagnostics models for building HVAC systems. Further, because the process is automated, it enables low cost, scalable commissioning of building control and diagnostics systems.

The automated process determines and sets up dedicated, functional tests on desired components of the HVAC system. The functional tests include generating a sequence of inputs for the component that affect the outputs of the component (rather than wait for such conditions to occur). The inputs are generated to excite the component into wide and varied operating conditions. The outputs are monitored and a model or map of the component performance may subsequently be generated.

However, many HVAC systems include constraints that must be taken into account when running the functional tests. For example, two dampers may be tested at inputs between their fully closed positions and fully open positions, but the system may be constrained from operating both dampers in the fully open positions at the same time. Accordingly, the HVAC system is monitored to determine if the generated inputs violate any of the system constraints. If the constraints are not fulfilled, the automated process may perform a loop where the inputs are modified until all system constraints are satisfied. The constraints may be an exclusive relation between two functional tests due to thermal or air flow impact. For example, the AHU fan may be the air supplier for the VAV damper, which are upstream and downstream sub-systems. When conducting functional tests for the AHU outside air damper (OAD) that involves the control of the AHU fan, it may not be possible to conduct the VAV damper functional test simultaneously.

Once the generated component inputs are optimized, a model is generated that predicts the nominal behavior of the system and/or its individual components. The predicted outputs of the system may then be compared to actual outputs of the system to perform diagnostics and determine faults of the HVAC system/components.

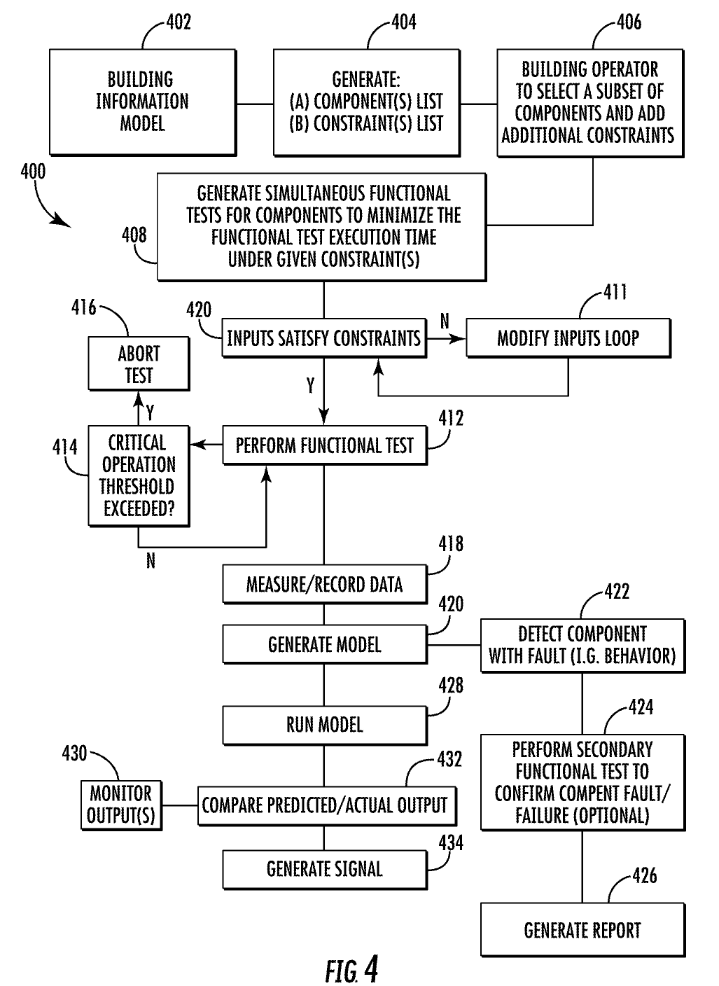

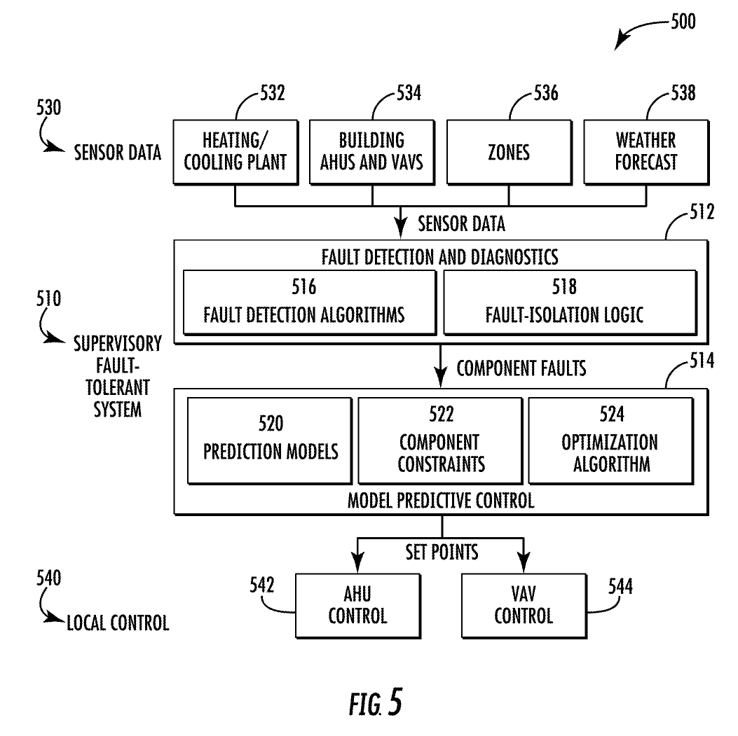

With reference to FIG. 4, a method 400 of generating statistical models of HVAC system components is described. Method 400 generates model(s) of component performance for HVAC diagnostics systems. The method includes, at step 402, obtaining the building information model. At step 404, the building information model is utilized to generate a list of components and a list of possible constraints for the executions of the functional test. At step 406, a controller or building operator may select a subset of components from the list generated in step 404 and may add additional constraints.

Step 408 includes generating combinations of input variables for all inputs of an HVAC system component. The combination of the inputs is based on the prior information obtained for the range and resolution of actuations for the components. An optimization routine such as stochastic gradient decent is utilized to arrive at the combination of inputs such that each component is run through all desired set of inputs and the system level constraints are satisfied at all times. At step 410, it is determined if the input combinations satisfy the constraints of the HVAC system. At step 411, if the constraints are not satisfied, the input combinations are modified in an optimization loop until the constraints are satisfied.

At step 412, if the constraints are satisfied, a functional test is performed on the component with the generated (and possibly modified) input combinations. At step 414, the critical operational criteria are continuously monitored and the test may be aborted (step 416) when critical threshold are exceeded. At step 418, component performance data is measured and recorded during the functional test. At step 420, a statistical prediction model is generated to map or describe the component output over the varied input combinations.

At step 422, the data obtained from the functional test are used to identify anomalies or faults in component behavior. Optionally, at step 424, additional functional tests may be performed to confirm the fault operation of the components. At step 426, a report is generated indicating the success/failure for individual components and their respective causes in addition to general statistics.

At step 428, the prediction model is then run during operation of the component to generate predicted outputs of the component. At step 430, the actual outputs of the component are monitored (e.g., continuously for extended periods of time). At step 432, the predicted outputs are compared with the actual outputs. At step 434, a signal indicative of a component fault is generated if the difference between the predicted component output and the actual component output is greater than a predetermined threshold.

In one exemplary operation, the input signal for a variable air volume (VAV) box in an HVAC system is the command position of the mechanical damper, or the flow set point, and the output is the rate of flow of air through the VAV. The functional test operates the VAV through the entire range of damper positions (0% open to 100% open) and measures the output of the component in terms of the air flow rate. The data collected is then used to construct a statistical model relating the input and the output.

The functional tests may be run for additional HVAC components such as fluid valves, air handling unit (AHU) fans, VAV dampers, AHU dampers, heat recovery wheel, water pump pressure, chiller/heat pump temperature set point, boiler temperature set point. Table 1 illustrates various HVAC components and their exemplary inputs, Table 2 illustrates exemplary HVAC constraints, and Table 3 illustrates a sample test output.

TABLE 1

| Component | Possible Component Inputs |
|---|---|
| On/off valve | On, Off |
| Proportional valve | 0%, 10%, 20%, . . . , 90%, 100% |
| Three stage fan | 0%, 33%, 67%, 100% |
| Air Damper | 0%, 10%, 20%, . . . , 90%, 100% |
| Water pump pressure | 50 kPa, 60 kPa, 70 kPa, 80 kPa, 90 kPa |

TABLE 2
HVAC Constraints

Total water flow rate <10 l/s
Total chiller capacity <120 kW
Total air handling unit flow rate <5.5 cubic meter/sec

TABLE 3

| | Sweep values | Input sequence of system | | | | | |
|---|---|---|---|---|---|---|---|
| Equipment | for actuator | actuators/setpoints | | | | | |
| Proportional | 0%, 10%, | 10% | 30% | 20% | . . . | 70% | 100% |
| Valve | 20%, . . . , | | | | | | |
| | 90%, 100% | | | | | | |
| Proportional | 0%, 10%, | 90% | 70% | 20% | . . . | 40% | 10% |
| valve | 20%, . . . , | | | | | | |
| | 90%, 100% | | | | | | |
| On/off Valve | On, Off | Off | Off | On | . . . | Off | On |
| Water pump | 60 kPa, | 60 | 90 | 60 | . . . | 90 | 60 |
| pressure | 90 kPa | | | | | | |

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of generating a model for HVAC system control, the method comprising:
generating a model of the performance of an HVAC system;
providing the generated model to at least one of an optimal control system and a diagnostic system; and
automatically tuning the HVAC system using the generated model and at least one of the optimal control system and the diagnostic system.

2. The method of claim 1, wherein the step of generating a model comprises:
generating a sequence of inputs of a component of the HVAC system to vary the operating conditions of the HVAC system; and
changing the inputs of the component, based on the generated sequence of inputs, to excite the HVAC system and vary the operating conditions of the HVAC system.

3. The method of claim 2, wherein the step of changing the inputs of the component comprises changing an inlet temperature of a heat exchanger, based on the generated sequence of inputs, to excite the HVAC system and vary the operating conditions of the HVAC system.

4. The method of claim 2, wherein the step of changing the inputs of the component comprises changing a supply temperature input of the component, based on the generated sequence of inputs, to excite the HVAC system and vary the operating conditions of the HVAC system.

5. The method of claim 2, wherein the step of changing the inputs of the component comprises changing an air flow input to the component, based on the generated sequence of inputs, to excite the HVAC system and vary the operating conditions of the HVAC system.

6. The method of claim 2, wherein the step of changing the inputs of the component comprises changing a water flow input to the component, based on the generated sequence of inputs, to excite the HVAC system and vary the operating conditions of the HVAC system.

7. The method of claim 1, further comprising monitoring disturbances to the HVAC system, and adjusting the model based on the monitored disturbances.

8. A method of generating a model for HVAC system control, the method comprising:
generating a combination of input variables for a component of an HVAC system;
performing a functional test on the component using the generated input combinations;
measuring performance data of the component during the functional test; and
generating a model of the component performance over generated input combinations.

9. The method of claim 8, further comprising determining if the generated input combination satisfied predetermined constraints of the HVAC system.

10. The method of claim 9, further comprising, modifying the input combination if the constraints are not satisfied.

11. The method of claim 8, further comprising running the generated model of the component performance during operation of the component to generate predicted outputs of the component.

12. The method of claim 11, further comprising:
measuring actual outputs of the component; and
comparing the predicted outputs with the actual outputs.

13. The method of claim 12, further comprising generating a signal indicative of a component fault if a difference between the predicted output and the actual output is greater than a predetermined threshold.

14. A method of controlling an HVAC system, the method comprising:
varying input parameters of the HVAC system;
measuring performance of the HVAC system while the input parameters are varied;
generating a model of the performance of the HVAC system based on the measured performance;
utilizing the generated model to automatically optimize the performance of the HVAC system; and
comparing actual outputs of the HVAC system with predicted outputs predicted by the model.

15. The method of claim 14, further comprising:
identifying failures of one or more components of the HVAC system;
calculating and updating control system parameters based on the identified component failures, wherein the control system parameters include at least one of HVAC component model parameters, control-objective coefficients, component operational constraints, and actuator operating ranges; and
modifying the control system parameters to maximize an occupant thermal comfort and minimize energy consumption, wherein the occupant thermal comfort is calculated based on deviations of space temperature from set points, and wherein the energy consumption is estimated based on the sum of HVAC component energy consumption.

16. The method of claim 14, further comprising:
indicating a component fault if a difference between the predicted output and the actual output is greater than a predetermined threshold;
modifying the input parameters based on the component fault indication; and
generating a report of the input parameter modification as a result of the component fault.
